(19) United States
(12) Patent Application Publication
(10) Pub. No.: US 2025/0008061 A1
(43) Pub. Date: Jan. 2, 2025

(54) MONITORING DEVICE AND MONITORING METHOD

(71) Applicant: MediaTek Singapore Pte. Ltd., Singapore (SG)

(72) Inventor: Bayi CHENG, Anhui (CN)

(21) Appl. No.: 18/659,569

(22) Filed: May 9, 2024

(30) Foreign Application Priority Data
Jun. 28, 2023 (CN) 202310780060.9

(51) Int. Cl. H04N 7/18; H04N 23/65

(52) U.S. Cl. CPC H04N 7/188; H04N 23/651

(57) ABSTRACT

The application discloses a monitoring method and a monitoring device. The monitoring device includes a motion detection unit and an AI decision-making unit. The motion detection unit is configured to detect moving objects to obtain monitoring data based on detection results and an AI decision. The AI decision-making unit is configured to utilize AI technology to obtain the AI decision based on the historical monitoring data and current time information of the monitoring device, to control the motion detection unit to be on and off. The application can improve the power-saving performance of the monitoring device while ensuring safety.

### CROSS REFERENCE TO RELATED APPLICATIONS

This application claims priority of China Patent Application No. 202310780060.9, filed on Jun. 28, 2023, the entirety of which is incorporated by reference herein.

### BACKGROUND OF THE INVENTION

### Field of the Invention

The application relates to the field of monitoring technology, and, in particular, to a monitoring method and a monitoring device.

### Description of the Related Art

In the related technology, when the motion detection function of the monitoring device is on, a fixed strategy will be adopted to wake up the monitoring device, so that the monitoring device can detect moving objects through the motion detection function. For example, the motion detection function of the monitoring device is turned on every 4 minutes or every 1 minute.

As a result, the power consumption will get larger when the related technology always turns on the motion detection function at fixed intervals. This is particularly inappropriate for devices with limited power (e.g., vehicular monitoring devices). Moreover, the usage habits of each monitoring device are different, so it is inappropriate to set the motion detection function of the monitoring device in a fixed way.

### BRIEF SUMMARY OF THE INVENTION

This application provides a monitoring method and a monitoring device, which can improve the power-saving performance of the monitoring device while ensuring safety.

To reach the above goal, the application provides a monitoring device. The monitoring device includes a motion detection unit configured to detect moving objects and obtain monitoring data based on detection results and an AI decision; and an AI decision-making unit configured to utilize AI technology to obtain the AI decision based on the historical monitoring data and current time information of the monitoring device, to turn the motion detection unit on and off.

In another embodiment, the AI decision-making unit is configured to utilize AI technology to obtain the AI decision based on the historical monitoring data of the monitoring device, to learn usage habits of an object to which the monitoring device belongs, and the AI decision is related to determining wake-up timing of the motion detection unit based on learning results and the current time information.

The monitoring device of this application is configured to utilize the AI technology to obtain the AI decision based on the historical monitoring data and the current time information of the monitoring device, to turn the motion detection unit on and off. That is, this application can adaptively adjust the wake-up timing of the motion detection function of each monitoring device based on the usage habit of the object to which each monitoring device belongs. For example, if the current monitoring device and/or the object to which the monitoring device belongs are determined to be in a safer state based on the historical monitoring data and the current time information of the monitoring device, then the detection time interval will be appropriately extended to reduce the power consumption caused by the motion detection function. This improves the power saving performance of the monitoring device while ensuring safety.

### BRIEF DESCRIPTION OF THE DRAWINGS

The accompanying drawings described here are for providing a further understanding of the present application and constitute a part of the present application. The illustrative embodiments of the present application and their descriptions are for explaining the present application and do not constitute an improper limitation on the present application. In the accompanying drawings:

FIG. 1 is a schematic structural diagram of a monitoring device according to an embodiment of the application;

FIG. 2 is a schematic flow diagram of a monitoring method adopted by the monitoring device of the application; and

FIG. 3 is schematic structural diagram of a computer-readable storage medium according to an embodiment of the application.

### DETAILED DESCRIPTION OF THE INVENTION

In the embodiments of the present application, the technical solutions will be clearly and completely described below with reference to the accompanying drawings. Apparently, the embodiments described are only some of the embodiments of the present application instead of all of the embodiments. Based on the embodiments in this application, all other embodiments obtained by those of ordinary skill in the art without creative efforts fall within the scope of protection of this application. Additionally, the term “or” used herein refers to a non-exclusive “or” (i.e., “and/or”) unless stated otherwise (e.g., “or additionally” or “or in the alternative”). Also, the various embodiments described herein are not necessarily mutually exclusive, as some embodiments may be combined with one or more other embodiments to form new embodiments.

In the related technology, when the motion detection function of the monitoring device is turned on, a fixed strategy will be adopted to wake up the monitoring device, so that the monitoring device can detect moving objects through the motion detection function. For example, the motion detection function of the monitoring device is turned on every 4 minutes or every 1 minute.

As a result, the power consumption will get larger when the related technology always turns on the motion detection function at fixed intervals. This is particularly inappropriate for devices with limited power (e.g., vehicular monitoring devices). Moreover, the usage habits of each monitoring device are different, so it is not appropriate to set the motion detection function of the monitoring device in a fixed way.

Accordingly, this application proposes a monitoring device. The monitoring device uses AI technology to obtain the AI decision based on the historical monitoring data and current time information of the monitoring device, to turn the motion detection unit on and off. That is, this application can adaptively adjust the time to turn on the motion detection function of each monitoring device according to the usage habit of the object each monitoring device belongs to. For example, if the current monitoring device and the object it belongs to is confirmed to be in a safe status based on its historical monitoring data and the current time information, then the time interval to detect motion is appropriately extended to reduce the power consumption caused by the motion detection function. This improves the performance on power saving of the monitoring device while ensuring safety.

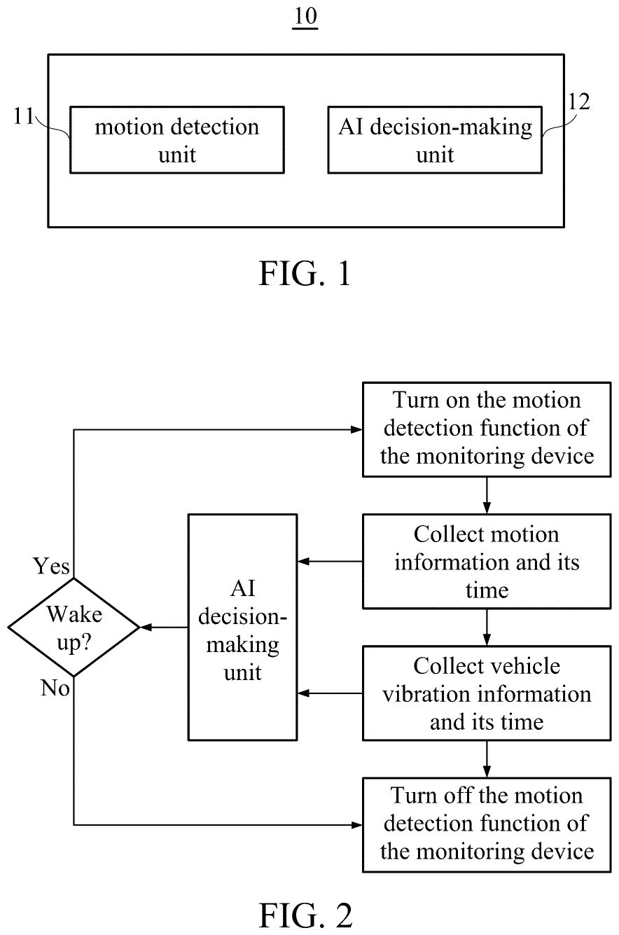

Specifically, as shown in FIG. 1, an embodiment of the present invention provides a monitoring device 10 including a motion detection unit 11 and an AI decision-making unit 12.

Wherein, the motion detection unit 11 is configured to detect moving objects to obtain monitoring data based on the detection results and an AI decision. Optionally, when the motion detection unit 11 is turned on, it can identify changes in the picture and detect the presence of moving objects. If the motion detection unit 11 detect that there is a moving picture (i.e., when a moving object appears in the shooting picture), it can record video automatically to obtain monitoring data.

The AI decision-making unit 12 may be configured to utilize AI technology to obtain the AI decision, based on the historical monitoring data and current time information of the monitoring device 10 to turn the motion detection unit 11 on and off.

Optionally, the AI decision-making unit 12 may utilize AI technology to obtain the AI decision based on the historical monitoring data and the current time information of the monitoring device 10, to infer the current usage scenario of the object with the monitoring device 10, and may turn the motion detection unit 11 on and off based on the current usage scenario. For example, if the current time information is 10:00 am on Friday, and the historical monitoring data shows that the object with the monitoring device 10 was located in the workplace, a safer area, of the user of the monitoring device 10 at 10:00 am on each previous Friday, then the current usage scenario of the object with the monitoring device 10 can be inferred to be the workplace, a safer area, of the owner of the monitoring device 10. Therefore, the motion detection unit 11 can be turned on at a relatively low frequency. Optionally, the usage habits and preferences of the object with the monitoring device 10 can be learned based on the historical monitoring data of the monitoring device 10. Thus, the analysis and inference on the current usage scenario of the object with the monitoring device 10 can be performed based on the learning results to determine the time interval to detect motion and/or the wake-up timing of the motion detection unit 11. This further controls the motion detection unit 11 to be turned on and off.

Further, if the monitoring device 10 is a vehicular monitoring device 10 (i.e., the object with the monitoring device 10 is a vehicle), the AI decision-making unit 12 can use AI technology to obtain the AI decision based on the data from vehicle sensors (e.g., the monitoring device 10, location sensors, and radar sensors), to learn the usage habits of the object with the monitoring device 10. Then, the time interval to detect motion and/or the wake-up timing of the motion detection unit 11 is adjusted based on the learned driving habits and preferences of the vehicle user.

Optionally, the AI decision-making unit 12 can use AI technology to obtain the AI decision to analyze and learn data from vehicle sensors (e.g., radar, camera, GPS), and learn the driving habits and the preferences (e.g., whether the owner is at home or at work at the specific time) of the vehicle owner to adjust the wake-up timing. The AI decision-making unit 12 can perform AI analysis and inference to determine the best wake-up timing. In this way, a flexible method can be adopted to replace the current fixed 4-minute wake-up mechanism, and the motion detection unit 11 can be intelligently turned on and off to ensure vehicle safety and power saving.

Wherein, when the AI decision-making unit 12 learns vehicle usage habits, the location sensor can be configured to provide vehicle location information in historical time, so that the AI decision-making unit 12 can learn the address where the vehicle is often parked. In addition, the AI decision-making unit 12 can learn the address attributes of each frequently parked address by combining the historical location and time information of the vehicle (i.e., learn whether each address where the vehicle is often parked is the vehicle user's home address or office address, etc.).

When the AI decision-making unit 12 learns vehicle usage habits, the monitoring device 10 can be configured to provide historical monitoring data, so that the AI decision-making unit 12 uses AI technology to obtain the AI decision to learn the historical occurrence frequency of moving pictures and/or historical object traffic in each period. Object traffic can refer to human traffic and/or vehicle traffic, etc.

Optionally, the wake-up timing of the motion detection unit 11 can be adjusted based on historical object traffic at each time. In general, the wake-up frequency of the motion detection unit 11 during times when historical object traffic is high will be higher than the wake-up frequency during times when historical object traffic is low. Alternatively, the wake-up timing of the motion detection unit 11 can also be adjusted based on the historical occurrence frequency of moving pictures at each time. Generally, the wake-up frequency of the motion detection unit 11 at a time when the historical occurrence frequency of moving pictures is relatively high will be higher than the wake-up frequency at a time when the historical occurrence frequency of moving pictures is relatively low. Preferably, the wake-up frequency of the motion detection unit 11 at a time is set to be higher than or equal to the historical occurrence frequency of moving pictures at that time. Of course, the wake-up timing of the motion detection unit 11 can also be comprehensively adjusted based on the historical object traffic and the historical occurrence frequency of moving pictures at each time.

Further, the AI decision-making unit 12 can combine the vehicle location information and the historical monitoring data to learn the historical object traffic and the historical occurrence frequency of moving pictures at each time. As a result, if the current location of the object with the monitoring device 10 is a frequently parked location, the wake-up timing of the motion detection unit 11 can be adjusted based on the historical occurrence frequency of moving pictures and/or the historical object traffic of the current location and the current time. If the historical occurrence frequency of moving pictures and/or the historical object traffic of the current location and the current time is higher, then the wake-up frequency of the motion detection unit 11 is set higher. That is, the detection time interval of the motion detection unit 11 is set shorter. If the historical occurrence frequency of moving pictures and/or the historical object traffic of the current location and the current time is lower, the wake-up frequency of the motion detection unit 11 is set lower. That is, the detection time interval of the motion detection unit 11 is set longer.

Wherein, the historical occurrence frequency of moving pictures at each time can be obtained based on the statistics of the historical occurrence frequency of moving pictures corresponding to each of the time periods before the current time period. Correspondingly, the historical object traffic at each time can also be obtained based on the statistics of the historical object traffic corresponding to each of the time periods before the current time period. In addition, the above time periods can be set according to actual conditions (e.g., set to one week or one day). Of course, in some implementations, the time period can also be determined by the AI decision-making unit 12 itself using AI technology to obtain the AI decision and learning from data from vehicle sensors (e.g., the monitoring device 10, location sensors, and radar sensors).

When the AI decision-making unit 12 uses AI technology to obtain the AI decision to learn vehicle usage habits, the radar sensor can be configured to provide information about whether there are other vehicles or obstacles around the vehicle with the monitoring device 10. This enables the AI decision-making unit 12 to learn the density of vehicles and other objects at the location of the monitoring device 10, so that the AI decision-making unit 12 can learn information such as the historical density of the area where the vehicle is located at each time. In this way, the wake-up timing of the motion detection unit 11 can be adjusted based on the historical density of the area where the vehicle is located at each time. Generally, the wake-up frequency of the motion detection unit 11 at times with high historical density is higher than that at times with low historical density. Further, the AI decision-making unit 12 can combine the vehicle location information and the radar sensor data to learn the historical density of each location at each time. Further, if the current location of the object with the monitoring device 10 is a frequently parked location, it can adjust the wake-up timing of the motion detection unit 11 based on the historical density of the current location and the current time. Furthermore, the AI decision-making unit 12 can combine vehicle location information, historical monitoring data and radar sensor data to learn the historical density of each location at each time, as well as the historical occurrence frequency of moving pictures and/or historical object traffic, etc. Therefore, if the current location of the object with the monitoring device 10 is a location where the vehicle with the monitoring device 10 often parks, the wake-up timing of unit 11 can be comprehensively adjusted based on the historical density, the historical occurrence frequency of moving pictures and/or the historical object traffic of the current location and the current time.

When the AI decision-making unit 12 uses AI technology to obtain the AI decision to learn vehicle usage habits, it may also combine data from the gravity sensor to learn the usage habits. Wherein, the gravity sensor can provide historical vibration data of the vehicle, so that the AI decision-making unit 12 can learn the historical vibration frequency and/or historical vibration intensity of the vehicle at each time. This enables the AI decision-making unit 12 to learn the historical vibration situations (e.g., historical vibration frequency and/or historical vibration intensity) of the vehicle, so that the AI decision-making unit 12 can learn the historical occurrence frequency of nearby moving objects of the vehicle at each time. In this way, the wake-up timing of the motion detection unit 11 can be adjusted based on the historical occurrence frequency of nearby moving objects of the vehicle at each time. Generally, the wake-up frequency of the motion detection unit 11 at times when moving objects appear frequently in historical time is higher than that at times when moving objects appear less frequently in historical time. Further, the AI decision-making unit 12 can combine the vehicle location information and the gravity sensor data to learn the historical occurrence frequency of nearby moving objects of each location and each time. As a result, if the current location of the object with the monitoring device 10 is a frequently parked location, the wake-up timing of the motion detection unit 11 can be adjusted based on the historical occurrence frequency of nearby moving objects of the current time and the current location. Furthermore, the AI decision-making unit 12 can combine the vehicle location information, the historical monitoring data and the gravity sensor data to learn the historical occurrence frequency of nearby moving objects, the historical occurrence frequency of moving pictures, and/or the historical object traffic of the current time and the current location, etc. Therefore, if the current location of the object with the monitoring device 10 is a location where the vehicle with the monitoring device 10 often parks, the wake-up timing of the motion detection unit 11 can be comprehensively adjusted based on the historical occurrence frequency of nearby moving objects, the historical occurrence frequency of moving pictures, and/or the historical object traffic of the current time and the current location. Furthermore, the AI decision-making unit 12 can combine the vehicle location information, historical monitoring data, radar sensor data and gravity sensor data to learn the historical density, the historical occurrence frequency of nearby moving objects, the historical occurrence frequency of moving pictures and/or historical object traffic of each location and each time, etc. Therefore, if the current location of the object with the monitoring device 10 is a location where the vehicle with the monitoring device 10 often parks, the wake-up timing of the motion detection unit 11 can be comprehensively adjusted based on the historical density, the historical occurrence frequency of nearby moving objects, the historical occurrence frequency of moving pictures and/or the historical object traffic of the current location and the current time.

After using AI technology to obtain the AI decision and learning vehicle usage habits through the above data, the AI decision-making unit 12 can obtain the historical reference data of the current location and the current time (e.g., the above-mentioned historical density, historical occurrence frequency of nearby moving objects, historical frequency of appearance of moving picture, and/or historical object traffic, etc.) based on the current time information and the current location information. Then, the wake-up timing and/or detection time interval of the motion detection unit 11 can be determined based on the historical reference data of the current location and the current time. That is, the motion detection unit 11 is turned on and off based on the historical reference data of the current location and the current time. In this way, the motion detection unit 11 is turned on and off based on the usage habits of the object with the monitoring device 10. This can reduce the power consumption of the motion detection unit 11 while ensuring safety.

Preferably, the AI decision-making unit 12 can also use AI technology to obtain the AI decision based on the historical reference data of the current location and the current time and the current detection data of the radar sensor, to comprehensively determine the wake-up timing and/or detection time interval of the motion detection unit 11. Of course, in some implementations, the AI decision-making unit 12 can also use AI technology to obtain the AI decision solely based on historical reference data of the current location and the current time, to determine the wake-up timing and/or detection time interval of the motion detection unit 11.

In an optional implementation, if the historical reference data of the current location and the current time cannot be obtained based on the current time information and the current location information due to too small amount of reference data, etc., the motion detection unit 11 can be awakened at a first time interval. The first time interval can be set according to the actual situation, such as 30s or 4 min, etc. There is no limit here. Preferably, the first time interval can be set shorter (e.g., less than or equal to 4 minutes). That is, when the amount of reference data is too small, the current safety factor of the object with the monitoring device 10 is considered to be relatively low. Enabling the motion detection unit 11 to maintain a high frequency of being wake-up allows the monitoring device 10 to obtain more learning data as fast as possible and improves the safety of the object with the monitoring device 10.

In another optional implementation, if the historical reference data of the current location at the current time can't be obtained due to too small amount of the reference data caused by the reason that the current location isn't an address frequently visited by the object with the monitoring device 10 (e.g., the amount of the detection data of the current location detected by the location sensor is smaller than a first threshold), then the motion detection unit 11 can be awakened at a first time interval. Alternatively, the motion detection unit 11 can be awakened at a second time interval, and the second time interval is shorter than the first time interval. If the historical reference data of the current location at the current time can't be obtained due to too small amount of the reference data caused by the reason that the object with the monitoring device 10 does not often appear at the current position at the time corresponding to the current time (e.g., the frequency that the object with the monitoring device 10 appears at the current position at the time corresponding to the current time is smaller than a second threshold), then the wake-up timing of the motion detection unit 11 can be determined based on the historical reference data of the current location and other times. Wherein, the time corresponding to the current time is the time corresponding to the current time in multiple time periods before the current time period. For example, if the length of a time period is 1 day and the current time is 10:00 am, then the time corresponding to the current time is 10:00 am every day. It can be understood that the above-mentioned first threshold and second threshold can be set according to actual conditions, and are not limited here. For example, the first threshold may be 3 or 5, and the second threshold may be 2 or 6.

In an example, determining the wake-up timing of the motion detection unit 11 based on the historical reference data of the current location and other times can be understood as follows: if the historical reference data of the current location and different times is diversified (i.e., the historical reference data of the current location at different times fluctuates), then the motion detection unit 11 can be awakened at the first time interval or the second time interval. If the historical reference data of the current location and different times is not significantly different (i.e., the fluctuation in the historical reference data of the current location at different times can be ignored), then the wake-up timing of the motion detection unit 11 can be determined based on the historical reference data of the current location and any time.

In another example, determining the wake-up timing of the motion detection unit 11 based on the historical reference data of the current location and other times can be understood as follows: determining the wake-up timing of the motion detection unit 11 based on the historical reference data of the current location and a first time. Wherein, the first time may refer to the time closest to the current time among the times at which the historical reference data of current location can be obtained.

In yet another example, determining the wake-up timing of the motion detection unit 11 based on the historical reference data of the current location and other times can be understood as follows: determining the wake-up timing of the motion detection unit 11 based on the historical reference data of the current location and any time other than the current time.

In addition, the AI decision-making unit 12 may also be configured with a feedback mechanism. That is, after the AI decision-making unit 12 determines the wake-up timing of the motion detection unit 11 based on the learned usage habits, it may further adjust the wake-up timing of the motion detection unit 11 (i.e., the detection time interval) based on the current detection results of the motion detection unit 11 and/or the current detection data of the gravity sensor and/or the radar sensor.

For example, if the AI decision-making unit 12 adjusts the wake-up timing of the motion detection unit 11 based on learned usage habits and no moving object is detected based on the current multiple detection results of the motion detection unit 11, the detection time interval can be further extended. That is, the motion detection unit 11 can be awaken at a lower frequency. Preferably, when the feedback mechanism is adopted to adjust the wake-up timing of the motion detection unit 11, the detection data of the gravity sensor and/or the radar sensor in the current time period can also be referred. That is, preferably, if the AI decision-making unit 12 adjusts the wake-up timing of the motion detection unit 11 based on learned usage habits, no moving object is detected based on the current multiple detection results of the motion detection unit 11, and the detection data of the gravity sensor and/or the radar sensor in the current time period isn't abnormal, then the detection time interval can be further extended. That is, the motion detection unit 11 can be awakened at a lower frequency. Optionally, the method of extending the detection time interval is not limited here. For example, the detection time interval can be extended by adding a fixed step size to the current detection time interval. For another example, the current detection time interval can be extended by a fixed ratio to obtain an extended detection time interval.

In another example, if the AI decision-making unit 12 adjusts the wake-up timing of the motion detection unit 11 based on the learned usage habits, and all moving objects are detected based on the current multiple detection results of the motion detection unit 11, the detection time interval can be shortened. That is, the motion detection unit 11 can be awakened at a higher frequency. And/or, if the AI decision-making unit 12 adjusts the wake-up timing of the motion detection unit 11 based on learned usage habits and the detection data of the gravity sensor and/or the radar sensor are found to be abnormal multiple times when the motion detection unit 11 is turned off, then the detection time interval can be shortened. That is, the motion detection unit 11 can be awakened at a higher frequency. And/or, if the AI decision-making unit 12 adjusts the wake-up timing of the motion detection unit 11 based on learned usage habits and the detection data of the gravity sensor and/or the radar sensor are found to be abnormal multiple times when the motion detection unit 11 is turned off, then the subsequent time to turn on the motion detection unit 11 can be adjusted to match the time when abnormality occurs in the detection data of the gravity sensor and/or the radar sensor. For example, the detection data of the gravity sensor and/or the radar sensor are abnormal at 10:07, 10:17, and 10:27. Although the detection time interval of the motion detection unit 11 is 10 minutes, the motion detection unit 11 is turned on at 10:00, 10:10, 10:20, and 10:30 (i.e., the time to turn on the motion detection unit 11 does not match the time when the detection data of the gravity sensor and/or the radar sensor is abnormal). In this way, the next time to turn on the motion detection unit 11 can be advanced from 10:40 to 10:37, and the motion detection unit 11 is subsequently turned on at intervals of 10 minutes. Optionally, the above-mentioned method of shortening the detection time interval is not limited here. For example, the detection time interval can be shortened by subtracting a fixed step from the current detection time interval. For another example, the current detection time interval can be reduced by a fixed ratio to obtain a shortened detection time interval.

It can be understood that, after a period of learning vehicle usage habits through relevant data, while determining the wake-up timing and/or detection time interval of the motion detection unit 11 based on the current time information and learning results, monitoring data, time information, location information, radar detection data, vibration detection data at the current time and other current detection data can also be collected. These continuously collected detection data can be used for re-learning vehicle usage habits, so that the learned vehicle usage habits get closer to the real usage habits of the vehicle. Accordingly, it is more easily to determine the wake-up timing of the motion detection unit 11 accurately.

Optionally, in the initial stage of using the monitoring device 10, the motion detection function of the monitoring device 10 can be turned on at fixed intervals (e.g., waking up the motion detection unit 11 of the monitoring device 10 every first interval or second interval). As shown in FIG. 2, after waking up the motion detection function of the monitoring device 10, motion information (may refer to moving pictures, etc.), the occurrence time of the motion information, vehicle vibration information and vibration time, etc. can be collected. Then, the motion detection function of the monitoring device 10 is turned off. The AI decision-making unit 12 can use AI technology to obtain the AI decision based on the dynamic information and the vibration information collected in the initial stage, to learn usage habits. The AI decision-making unit 12 can determine when to wake up (i.e., turn on) and turn off the motion detection function of the monitoring device 10 based on the latest learning results. During the period when the motion detection function of the monitoring device 10 is turned on, the monitoring device 10 will also collect information such as motion information, the occurrence time of motion information, vehicle vibration information and vibration time, etc. Also, the AI decision-making unit 12 will use AI technology to obtain the AI decision based on the newly collected motion information, vibration information and so on, to re-learn usage habits. That is, during the use of the monitoring device 10, the AI decision-making unit 12 continues to learn the usage habits and usage scenarios of the object to with the monitoring device 10. The AI decision-making unit 12 will determine when to wake up and turn off the motion detection function of the monitoring device 10 based on the latest learning results. In this way, through continuous data collection and learning, the usage habits learned by the AI decision-making unit 12 of the monitoring device 10 using AI technology are closer to the real usage habits of the vehicle. As a result, it is more easily to accurately determine the wake-up timing of the motion detection unit 11, so that the motion detection function of the camera is turned off in appropriate circumstances to achieve the goal of power saving.

In addition, when the vehicle is in a stopped state, the above-mentioned strategy can be adopted to turn the motion detection unit 11 on and off, so as to improve the power-saving efficiency with the consideration of the vehicle safety when the vehicle power supply is limited.

This application also provides a monitoring method. The monitoring method of this application includes the step of turning the motion detection function of the monitoring device on and off based on the historical monitoring data and current time information of the monitoring device. For further details of this step, refer to the relevant description of the AI decision-making unit, which is not repeated here.

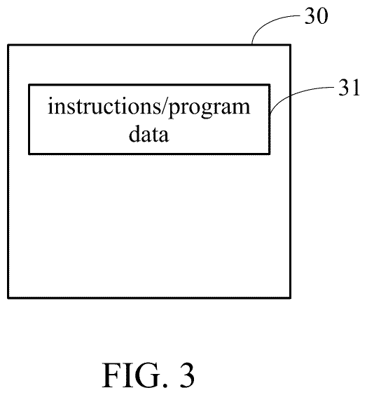

FIG. 3 is a schematic structural diagram of a computer-readable storage medium in an embodiment of the present application. The computer-readable storage medium 30 of the embodiment of the present application stores instructions/program data 31. When the instructions/program data 31 are executed, the methods provided by any embodiment of the monitoring device of the present application and any non-conflicting combination are implemented. Wherein, the instructions/program data 31 can form a program file and be stored in the above-mentioned storage medium 30 in the form of a software product, so that a computer device (can be a personal computer, a server, or a network device, etc.) or a processor can perform all or part of the steps of each embodiment of the present application. The aforementioned storage medium 30 includes any media that can store program codes (e.g., U disk, mobile hard disk, read-only memory (ROM), random access memory (RAM), magnetic disk or optical disk, etc.) or terminal devices (e.g., computers, servers, mobile phones, and tablets).

In the several embodiments provided in this application, it should be understood that the disclosed systems, devices and methods can be implemented in other ways. For example, the device embodiments described above are only illustrative. For example, the division of units is only a logical function division. In actual implementation, there may be other division methods. For example, multiple units or components may be combined or integrated to another system, or some features can be ignored, or not implemented. On the other hand, the (direct) coupling or communication connection between each other shown or discussed may be through some interfaces. The indirect coupling or communication connection of the devices or units may be in electrical, mechanical or other forms.

In addition, each functional unit in each embodiment of the present application can be integrated into one processing unit, or exist physically alone. Also, two or more units can be integrated into one unit. The integrated units can be implemented in the form of hardware or software functional units.

It should also be noted that the terms “comprises,” “includes,” or any other variation thereof are intended to cover a non-exclusive inclusion. Accordingly, a process, method, article, or apparatus that includes a list of elements not only includes those elements, but also includes other elements that are not expressly listed or that are inherent. Without further limitation, an element qualified by the statement “comprises a . . . ” does not exclude the presence of additional identical elements in the process, method, product, or device that includes the element.

The above are only embodiments of the present application, and do not limit the patent scope of the present application. Any modification on equivalent structure or equivalent process made using the description and drawings of this application, or direct or indirect application in other related technical fields are all included in the patent protection scope of this application.

What is claimed is:

1. A monitoring device, comprising:
a motion detection unit, configured to detect moving objects and obtain monitoring data based on detection results and an AI decision; and
an AI decision-making unit, configured to utilize AI technology to obtain the AI decision based on historical monitoring data and current time information of the monitoring device, to control the motion detection unit to be on and off.

2. The monitoring device as claimed in claim 1, wherein the AI decision-making unit is configured to utilize AI technology to obtain the AI decision based on the historical monitoring data of the monitoring device, to learn usage habits of an object to which the monitoring device belongs, and the AI decision is related to determining wake-up timing of the motion detection unit based on learning results and the current time information.

3. The monitoring device as claimed in claim 2, wherein the object to which the monitoring device belongs is a vehicle, the vehicle is provided with a location sensor, a radar sensor and/or a gravity sensor, and
the AI decision-making unit is configured to utilize the AI technology to obtain the AI decision based on detection data of the location sensor, the radar sensor and/or the gravity sensor and the historical monitoring data, to learn the usage habits of the object to which the monitoring device belongs, and the AI decision is related to determining the wake-up timing of the motion detection unit based on the learning results and the current time information.

4. The monitoring device as claimed in claim 3, wherein the AI decision-making unit is configured to utilize AI technology to obtain the AI decision based on the learning results, the current time information, and current location information of the location sensor, to determine the wake-up timing of the motion detection unit.

5. The monitoring device as claimed in claim 4, wherein the AI decision-making unit is configured to utilize AI technology to obtain the AI decision based on the current time information and the current location information, to obtain historical reference data of the current location and current time, and the AI decision is related to determining the wake-up timing of the motion detection unit based on the historical reference data of the current location and the current time;
wherein the historical reference data of the current location and the current time comprises historical density of the current location, historical occurrence frequency of nearby moving objects, historical occurrence frequency of moving pictures and/or historical object traffic at the current time.

6. The monitoring device as claimed in claim 5, wherein the AI decision-making unit is configured to wake up the motion detection unit at a first time interval when failing to obtain the historical reference data of the current location at the current time; and/or
wherein the AI decision-making unit is configured to determine the wake-up timing of the motion detection unit based on the historical reference data of the current location in the remaining time when failing to obtain the historical reference data of the current location at the current time.

7. The monitoring device as claimed in claim 2, wherein the object to which the monitoring device belongs is a vehicle, the vehicle is configured with a radar sensor and/or a gravity sensor, and after determining the wake-up timing of the motion detection unit based on the learning results and the current time information, the AI decision-making unit utilizes the AI technology to obtain the AI decision based on current detection results of the motion detection unit and/or current detection data of the gravity sensor and/or the radar sensor, to adjust the wake-up timing of the motion detection unit.

8. The monitoring device as claimed in claim 7, wherein:
the AI decision-making unit reduces wake-up frequency of the motion detection unit in response to no moving objects detected in the current detection results of the motion detection unit; and/or
the AI decision-making unit increases the wake-up frequency of the motion detection unit in response to the moving objects detected in the current detection results of the motion detection unit; and/or
the AI decision-making unit is configured to increase the wake-up frequency of the motion detection unit in response to an abnormal frequency of the detection data of the gravity sensor and/or the radar sensor when the motion detection unit is off.

9. A monitoring method, comprising:
utilizing AI technology to obtain an AI decision based on historical monitoring data and current time information of the monitoring device, to control motion detection function of a monitoring device to be on and off.

10. A computer-readable storage medium, storing instructions/program data, wherein steps of the monitoring method as claimed in claim 9 are implemented when the instructions/program data are executed.
